(19) United States
(12) Patent Application Publication
(10) Pub. No.: US 2003/0222899 A1
(43) Pub. Date: Dec. 4, 2003

(54) System and method for creating multimedia presentation

(76) Inventor: Antero Alvesalo, Espoo (FI)

Correspondence Address: SALTAMAR INNOVATIONS, 30 FERN LANE, SOUTH PORTLAND, ME, 04106, US

(21) Appl. No.: 10/174,740

(22) Filed: Jun. 19, 2002

(30) Foreign Application Priority Data
May 31, 2002 (FI) 20021048

(51) Int. Cl. G09G 5/00

(52) U.S. Cl. 345/716; 345/730

(57) ABSTRACT

This invention relates to creating a multimedia show. A multimedia mobile terminal acts as a control panel for creating the multimedia show. The actual work for making the multimedia show is made in an editor tool, preferably in a server of a communication network. When the user of the multimedia mobile terminal desires to create a multimedia show, he may ask for templates or a certain template for the show from the server. The server sends the requested template to the mobile terminal. The user can select content components into the template that is the structure of the multimedia show. The content components are according to the template, for example, video clips, audio clips, text, images or another content type, When the content components are defined, the references to the content components and the template are sent from the mobile terminal to the server, for the editor tool to create the show.

### FIELD OF THE INVENTION

This invention relates to creating a multimedia show. The multimedia show comprises several elements, which can be different content types, such as video, text, image, logo, drawing, transition, special effects, and audio. More particularly, the invention relates to creating a multimedia show in a mobile terminal and in a communication network.

### BACKGROUND OF THE INVENTION

It is common desire among users to create a multimedia show and deliver it to others (for example to document a vacation or similar event), however present solutions are relatively large and tedious to use for the average user. The user has to use a powerful computer with a dedicated software tool, or an advanced mobile terminal with multimedia features.

The software tools require large processing capacity, since otherwise handling of images and videos is practically impossible. Further, the software tools usually contain various special features, such as transitions and filters for creating desired effects.

The mobile terminal solutions are not as sophisticated as the common software tools for creating multimedia shows used on general purpose computers memory and processing capacity of a mobile terminal are more limited. Therefore, creating outstanding multimedia shows in a mobile terminal is not presently feasible. Further, most present solutions require familiarity with the SMIL (Synchronized Multimedia Integration Language) language. SMIL is very similar to the HTML language, but it provides other functionality tailored directly to multimedia requirements. SMIL documents (or program scripts) can be written using any text editor. A SMIL presentation is constructed from different elements, such as audio, video, text, and images. Although, the SMIL language is considered to be easy to use and learn, it requires a relatively good knowledge and skills to use it well in practice. Many users consider this too tedious. Generally, the SMIL presentations are transmitted to mobile terminals via a MMS (Multimedia Messaging Service) service, which works somewhat like SMS (Short Messaging Service) service.

Presently available mobile phones do not support video clips, so it is only possible to include still images, text, and audio clips with limited features in a multimedia show directed to mobile phones. It is possible to take pictures and record audio clips in the multimedia mobile phone, but really advanced multimedia functions are beyond the capabilities of the phone.

The goal of the invention is to provide a solution for the users of the multimedia mobile terminals to create a number of different multimedia shows with different advanced features.

### SUMMARY OF THE INVENTION

An important concept of the invention involves viewing the multimedia mobile terminal as a control panel for creating a multimedia show, although a fixed terminal may be similarly used. The actual work of making the multimedia show is carried out in a special editor tool, preferably in a server coupled to a communication network. When the user of the multimedia mobile terminal desires to create a multimedia show, he/she may ask for pre-made templates or a certain template for the show from the server. The server sends the requested templates or template to the mobile terminal. Now the user can select content components into the template, thus forming the structure of the multimedia show. The template comprises placeholders for content components. The content components are according to the template, for example, video clips, audio clips, text, images or another content type, When the content components are defined, the references of the content components, and the template, are sent from the mobile terminal to the server, for the editor tool. The content components may actually be situated in any location, from where they are transmitted to the editor tool for creating the multimedia show. It is also possible to send the actual content components from the mobile terminal to the server in place of the references of the thereto.

The editor tool creates the multimedia show, which may then be sent to any desired place.

The system comprises an editor tool, which is adapted to work with the control panel. The control panel defines a structure and content components for the multimedia show, and it is functionally connectable to the editor tool via a communication network.

The method comprises the steps of: providing a template for defining a structure for the multimedia show; defining content components into the template in a control panel by using references of the content components; transmitting the template and references of the content components from the control panel to an editor tool; and creating the multimedia show according to the template and the references in the editor tool.

### BRIEF DESCRIPTION OF THE DRAWINGS

In the following, the invention is described in greater detail, with the aid of the attached figures, in which:

FIG. 1 illustrates an example of a system according to the present invention.

FIG. 2 illustrates an example of a multimedia show template.

FIG. 3 illustrates an example of another multimedia show template.

FIG. 4 illustrates an example of the template of FIG. 2 in a multimedia mobile terminal.

FIG. 5 illustrates an example of the template of FIG. 3 in a multimedia mobile terminal.

FIG. 6 illustrates an example of phases of a method in accordance with the present invention.

### DESCRIPTION OF THE INVENTION

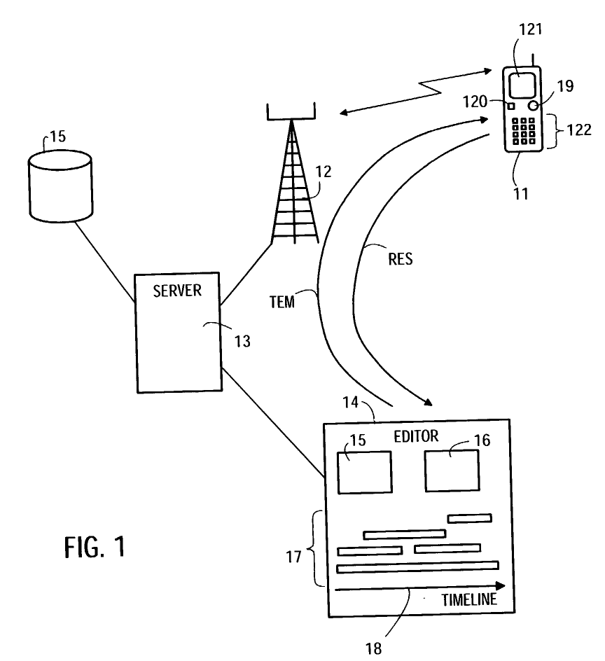

FIG. 1 illustrates an example of a preferred embodiment of a system according to the present invention. A multimedia mobile terminal 11 is connected to a communication network through a radio path. When the user of the terminal 11 desires to create a multimedia show, he sends a request for a template for the show. The request is transmitted via a base station 12 to a server 13 that is responsible for handling the request. The template may be in the server, or it may be in located in any location accessible to the server, such as a database 15. Furthermore and preferably, the server may contain an editor tool 14, which contains the template as well. The editor tool may also be in any suitably accessible location.

The user of the multimedia mobile terminal may also ask for several templates, if he wants to compare different choices. Naturally, the mobile terminal may already contain templates, in which case, the request for getting templates is not required. However, preferably the available templates are located in the editor tool 14. The editor tool is a sophisticated, usually software based, tool for creating multimedia shows. Often the editor comprises two display fields 15, 16 for showing the multimedia show under construction. The editor tool also comprises a timeline 18 with which different content components 17 of the multimedia show may be associated, forming the structure of the show.

The editor tool requires large processing power for running efficiently. A large amount of available memory is required as well. Due to this, it is evident that multimedia mobile terminals are not capable of making attractive multimedia shows. For example, special effects require large capacity. Transitions, different filters, duration adjustment of a clip etc. makes a multimedia show look more professional.

The templates are predefined structures for a multimedia show. For example, a template named: 2pict+text.temp may comprise two consecutive pictures and parallel text shown with the pictures. Let's assume the user of the mobile terminal 11 requests the template 2pict+text.temp from the editor tool 14. The editor tool sends the template TEM to the terminal. Using the keyboard 122 and the display 121 of the multimedia mobile terminal the user can place content components into the template. The content components may already be in the terminal, since many multimedia terminals can take a picture through a camera 19, and record audio clips through a microphone 120. Naturally, the content component may also be in any location accesible to he terminal or server, such as in database 15. The communication network can be a mobile network and/or a fixed network. The terminal has access to the references to the actual content components. The content components can be of different types, such as video or audio clips, text, still images or other material.

After defining the content components, the multimedia mobile terminal sends RES the template and the references of the content components (2pict+text.temp+refs) to the editor tool 14. If the content components are in the terminal, they are also sent to the editor tool. If the content components are in some other locations in the communication network, the editor tool can request them by using the references. Optionally, at least some content components are already in the editor tool. The editor tool uses the template, which dictates the structure of the multimedia show, for inserting the actual content components into the right places, and creates the desired multimedia show. Generally, the template is considered small enough to ignore its transmission, however if additional savings are desired, only the references to the content may be transmitted, and thus the template does not need to be sent back to the server. Naturally, either identification of the receiving terminal, a template number or any other common method to identify the template to which the content components relate and their placement within the template are also needed. Methods like that are common in the art and will not be farther discussed herein.

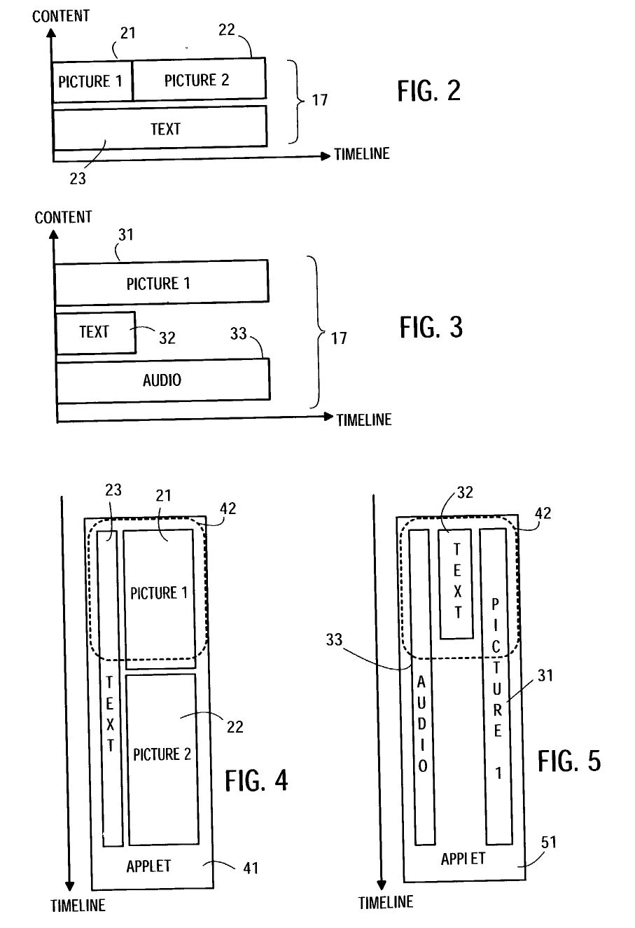

FIG. 2 illustrates an example of the multimedia show template of two consecutive pictures Picture 1 21 and picture 2 22, and accompanying text 23 to be displayed with the pictures. The picture and text components, i.e. component fields, form a structure of a multimedia show. By inserting the desired content components into their places, i.e. pictures into the picture components and text into the text component, the multimedia show is created. FIG. 2 shows the templates as preferably seen in the editor tool. FIG. 3 shows an example of another template, which comprises three components: an audio clip 33, a picture 31, and a short text 32. So, it possible to situate the component fields in parallel and/or one after another.

As previously noted, a number of different predefined templates may exist. The use of predefined templates makes it easier to construct a multimedia show, especially when using a multimedia mobile terminal as a control panel. It should also be noted that while the durations of an individual content component is usually fixed, however templates may contain options to either adjust the time allocated for specific components, or to constrain such components within the template predefined time period. As the option of defining durations consumes the capacity of the multimedia mobile terminal, it is recommended only in a high capacity multimedia mobile terminal (or in a fixed multimedia terminal).

FIG. 4 shows an example of the template of FIG. 2 in a multimedia mobile terminal. The terminal contains a locating function for inserting (or in other words, locating) desired content components into the template. The locating function uses the references of the contents, i.e. the actual location information and the names of the content components, for attaching the content components to the template, preferably at user located locations. The locating function may be achieved for example, by an applet 41 that is sent to the terminal together with the template information, or alternatively, the applet may already be in the terminal and capable to act as a platform for different templates. The template, which comprises place holders for the various content components such as picture 1 component 21, picture 2 component 22, and a text component 23, is preferably transmitted as an integral part of the applet. Preferably, an applet can be adapted to handle any desired template. The display 42 of the multimedia mobile terminal is illustrated as a dashed line. Since the display is usually small, it is difficult or even impossible to show the whole template in one screen. So the keyboard of the terminal is preferably used for scrolling the active view of the template. Preferably, the scrolling function is in a vertical direction, but a horizontal direction is possible as well. In general, the keyboard or other input and output components of the control panel are adapted to command the control panel, which in turn acts as a local or remote interface with the server, for creating the multimedia show.

Preferably, one button of the keyboard is defined as an activation button for activating the components of the template. For example, when the user wants to insert a picture in the picture 1 component placeholder 21, he moves the cursor of the display above the picture 1 placeholder, and clicks the activation button. Now, the applet is ready to situate the picture into the picture 1 component placeholder. The applet asks for the reference of the picture. Preferably, the applet can show a list of references from which the user can select the desired picture. In a similar way, a text reference is situated in the text component placeholder 23, and the other picture reference in the picture 2 component placeholder 22.

If the multimedia terminal is a high capacity terminal, optional features may be added in the templates and/or the applet. For example, the durations of the template components may be adjustable—the user can define the duration of each component. It may also be possible to add transitions between pictures (such as barn doors transition). Furthermore it may be possible to show a preliminary presentation of the multimedia show under construction. The number of options depends on the capacity of the terminal, and the applet/template design.

FIG. 5 shows an example of the template of FIG. 3 in a multimedia mobile terminal. As in FIG. 4, an applet 51 forms a platform for the template components, 31 to 33.

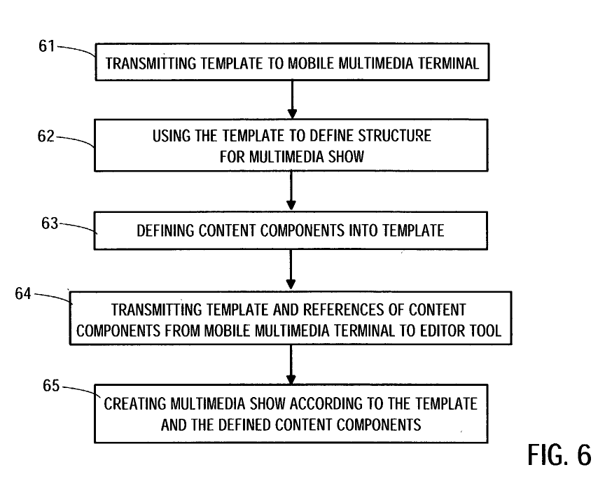

FIG. 6 shows an example of phases of the inventive method. It should be noted that some phases are not needed if the situation of creating a multimedia show does not require them. For example, the delivering phase 61 is not required, if the template is already in the multimedia mobile terminal. On the other hand, some additional phases may be added as needed, for example a transmitting phase of contents to the editor tool before creating 65 the multimedia show.

First, in response to a user request, a template or templates are transmitted 61 to the mobile multimedia terminal. Alternatively, the templates can already be in the terminal, then the request, and subsequent transmission, are not required. The template in the terminal is used 62 to define a structure for the multimedia show. Content components are defined 63 into the template by preferably using the references (address and name information) of the content components. After this, the template and the references of the content components are transmitted 64 from the mobile multimedia terminal to the editor tool. If the content components or at least one of them is in the mobile terminal, it must also be sent to the editor tool, either with the template or later when the editor tool requests them or it. After receiving the templates and references, the editor tool checks where the content components are. If the content components, such as video or audio clips, still pictures, and text, are somewhere different than the editor tool location, the editor tool requests them. The requested contents are transmitted to the editor tool. When the editor tool has all the content components, it creates 65 the desired multimedia show according to the structure of the template. When the multimedia show is ready, it can be delivered to any place the user of the mobile multimedia terminal defines, for example to friends' e-mail boxes, back to the mobile multimedia terminal, etc.

The invention is not restricted to the above-mentioned examples. The terminal of the user need not be a mobile terminal, or instead of using pre-defined templates, the user can create his own template. Due to this, it is evident that the invention can be used in a number of different solutions, in the scope of the inventive idea.

1. A system for creating a multimedia show, comprising:
a multimedia show editor tool adapted to cooperate with a control panel and communicate therewith via a communication network;
wherein said control panel is adapted for defining a structure and content components for a multimedia show.

2. A system according to claim 1, further comprising at least one template which defines a structure for the multimedia show.

3. A system according to claim 2, wherein the template is located remotely to said editor tool, and the template is transmitted to the control panel.

4. A system according to claim 3, wherein the control panel comprises software for locating the content components into the template.

5. A system according to claim 4, wherein said software for locating the content components is an applet

6. A system according to claim 4, wherein said locating means uses references of the content components when locating the content components into the template.

7. A system according to claim 5, wherein said locating means uses references of the content components when locating the content components into the template.

8. A system according to claim 6, wherein said references define the locations and names of the content components.

9. A system according to claim 7, wherein said references define the locations and names of the content components.

10. A system according to claim 8, wherein the editor tool is adapted to receive the template and the references to the content components via the communication network; and wherein the editor tool is further constructed to request the content components according to the information of the references, and create a multimedia show by placing said content components in accordance with placeholders defined in the template.

11. A system according to claim 9, wherein the editor tool is adapted to receive the template and the references to the content components via the communication network, and wherein the editor tool is further constructed to request the content components according to the information of the references, and create a multimedia show by placing said content components in accordance with placeholders defined in the template.

12. A system according to claim 2, wherein the template comprises at least one component field that is defined for a certain type of content.

13. A system according to claim 10, wherein the template comprises at least one component field that is defined for a certain type of content.

14. A system according to claim 11, wherein the template comprises at least one component field that is defined for a certain type of content.

15. A system according to claim 12, wherein the component fields are arranged to indicate that the content components which they respectively represent will be played simultaneously during playing of the multimedia show.

16. A system according to claim 13, wherein the component fields are arranged to indicate that the content components which they respectively represent will be played simultaneously during playing of the multimedia show.

17. A system according to claim 14, wherein the component fields are arranged to indicate that the content components which they respectively represent will be played simultaneously during playing of the multimedia show.

18. A system according to claim 12, wherein the component fields are arranged to indicate that the content components which they respectively represent will be played consecutively during playing of the multimedia show.

19. A system according to claim 13, wherein the component fields are arranged to indicate that the content components which they respectively represent will be played consecutively during playing of the multimedia show.

20. A system according to claim 14, wherein the component fields are arranged to indicate that the content components which they respectively represent will be played consecutively during playing of the multimedia show.

21. A system according to claim 1, wherein at least one of said content components is selected from a group consisting of video, image, audio, text, logo, drawing, transition, and special effects.

22. A system according to claim 12, wherein at least one of said content components is selected from a group consisting of video, image, audio, text, logo, drawing, transition, and special effects.

23. A system according to claim 13, wherein at least one of said content components is selected from a group consisting of video, image, audio, text, logo, drawing, transition, and special effects.

24. A system according to claim 14, wherein at least one of said content components is selected from a group consisting of video, image, audio, text, logo, drawing, transition, and special effects.

25. A system according to claim 1, wherein the control panel is a mobile terminal.

26. A system according to claim 12, wherein the control panel is a mobile terminal.

27. A system according to claim 21, wherein the control panel is a mobile terminal.

28. A system according to claim 25, wherein at least a part of a keyboard of the control panel is adapted to command the control panel for creating the multimedia show.

29. A system according to claim 26, wherein at least a part of a keyboard of the control panel is adapted to command the control panel for creating the multimedia show.

30. A system according to claim 27, wherein at least a part of a keyboard of the control panel is adapted to command the control panel for creating the multimedia show.

31. A system according to claim 1, wherein the communication network is a mobile network.

32. A system according to claim 30, wherein the communication network is a mobile network.

33. A system according to claim 1, wherein the communication network is a fixed network.

34. A system according to claim 30, wherein the communication network is a fixed network.

35. A method for creating a multimedia show, the method comprising the steps of:
using a template for defining a structure for the multimedia show,
in a control panel, defining content components in accordance with the template by using references to the content components,
transmitting the references of the content components from the control panel to an editor tool, and
creating a multimedia show in the editor tool according to the template and the references.

36. A method according to claim 35, wherein the method further comprises the step of transmitting the template to the control panel.

37. A method according to claim 35, wherein the method further comprises the step of transmitting the content components according to the references to the editor tool before creating the multimedia show.

38. A method according to claim 36, wherein the method further comprises the step of transmitting the content components according to the references to the editor tool before creating the multimedia show.

39. A method according to claim 35, wherein the method further comprises the steps of delivering the multimedia show to a desired place.

40. A method according to claim 36, wherein the method further comprises the steps of delivering the multimedia show to a desired place.

41. A method according to claim 37, wherein the method further comprises the steps of delivering the multimedia show to a desired place.

42. A method according to claim 38, wherein the method further comprises the steps of delivering the multimedia show to a desired place.

43. A method according to claim 35 further comprising the step of transmitting the template from the control panel to the editor tool.

44. A method according to claim 36 further comprising the step of transmitting the template from the control panel to the editor tool.

45. A method according to claim 37 further comprising the step of transmitting the template from the control panel to the editor tool.
